(19) United States
(12) Patent Application Publication
(10) Pub. No.: US 2026/0366330 A1
(43) Pub. Date: Nov. 19, 2026

(54) Rotary Handle For Swivel Doors Or Windows And Use thereof In A Pass Box For Clean Rooms

(71) Applicant: Kairish Innotech Private Ltd, Mumbai (IN)

(72) Inventors: Rishad Kairus Dadachanji, Mumbai (IN); Monik Vinodbhai Tandel, Mumbai (IN)

(21) Appl. No.: 19/664,237

(22) Filed: Apr. 30, 2026

(30) Foreign Application Priority Data
May 8, 2025 (IN) 202521044736
Jun. 23, 2025 (DE) 102025124131.7

(51) Int. Cl. E05B 13/00; E05C 3/04

(52) U.S. Cl. CPC E05B 13/002; E05C 3/042

(57) ABSTRACT

A rotary handle 3 for swivel doors 10 comprises a main body 30 including a locking member 17 rotatable about a rotation axis 5 between a locking condition, in which the door is locked by a locking member 17, and an opening condition, in which the door 10 is released for opening. A locking mechanism 8, 55, 53 automatically locks the rotary handle 3 both in the locking condition and in the opening condition.

When the door 10 is to be closed, the locking member 17 automatically remains locked in the second angular position. An accidental rotation of the rotary handle 3 in a non-locked state can be prevented, so that the locking member 17 cannot damage a gasket sealing an opening to be closed by the window.

A release member 8 of the locking mechanism is biased to a home position, in which the rotary handle 3 is locked.

### FIELD OF INVENTION

The present invention generally relates to rotary handles for doors or windows that can be pivoted or swiveled between a closed condition and an opened condition, for controlling opening and closing of such doors or windows, and particularly relates to a rotary handle for use in pass boxes for clean rooms, used for the transfer of an article into or out of a clean room.

### BACKGROUND OF INVENTION

A clean room is a controlled environment, contained space that has a low, or controlled, level of contaminants/pollutants such as dust, airborne microbes, aerosol particles, and chemical vapors. A pass box, also named pass-thru chamber, for clean rooms is an enclosed chamber with a door on a clean room side and at least one other door on another side. Such pass boxes are commonly used for the quick transfer of articles and materials between the clean room and an ambient side while minimizing contaminant transfer to help maintain the clean room environment. Because of their relatively small volume, such pass boxes can be cleaned easily and quickly, and thus help to reduce the risk of intrusion of contaminants into a clean room.

Accordingly, it is imperative to maintain the cleanliness of the pass-thru internal chamber.

The general configuration of such pass boxes is known e.g. from U.S. Pat. Nos. 11,136,814 B2 or 11,885,529 B2.

CN 204 511 106 U discloses a pass box comprising two doors disposed at opposite sides of the pass box. Each door is provided with a set of two rotary locking members that are supported on a common pivoting member connecting both sets of locking members. When the first set of locking members is in a locking condition locking the first door in a closed condition, the second set of locking members is in a release condition enabling opening the second door while the first door cannot be opened. On the other hand, when the second set of locking members is in a locking condition locking the second door in a closed condition, the first set of locking members is in a release condition enabling opening the first door while the second door cannot be opened. Thus, simultaneous opening of both doors is reliably prevented. The interplay of a locking mechanism, which locks the rotary handle both in the locking condition (e.g. locking member in horizontal direction) and in the opening condition (e.g. locking member in vertical direction) and a release member, enabling a pivoting of the rotary handle to the opening condition only after being actuated, and automatically locking the locking mechanism, once the opening condition is reached, prevents rotation of the rotary handle about the rotation axis when opening and closing the door or window, is not disclosed.

DE 20 2019 101 805 U1 discloses a door handle comprising a locking member 21, which locks the angular position of the door handle in a home position, to prevent small children from opening the door while being unattended. Locking the angular position is accomplished by the engagement of two pins extending radially outward from a main body of the door handle, which are received in two opposite gaps provided in a locking member. The door handle comprises an end piston that needs to be pulled outward (in axial direction) against the force of a spring integrated into the door handle, for releasing the locking of the angular position of the door handle and releasing the positive-fit engagement of the pins with the gaps of the locking member. As the door handle can only be rotated by a relatively small angle, the pins slide along the surface of the circular member and the door handle remains pivotable once the first angular position of the door handle is to its maximum opening position.

Pass boxes for clean rooms according to the prior art are typically of a configuration similar to that shown in FIG. 6, as disclosed in U.S. Pat. No. 11,885,529 B2. An opening is provided in a front sidewall 107 of the clean room 100, which is closed by a door 106, usually a glass door. A circumferential gasket is provided along the perimeter of the opening, which is clamped between the side-wall 107 and the door 106 in the closed condition of the door 106, to seal the inner volume of the pass box 105 against the outside on the front side-wall 107 of the pass box 105 and to seal the inner volume of the pass box 105 against the clean room 100 on the opposite rear side-wall of the pass box 105. The door 106 can be opened by pivoting about a vertical rotation axis 108. A locking member 110 is coupled with a rotary door handle 109 that can be rotated about a rotation axis between a first angular position, which is usually a horizontal position, in which the door 106 is locked at the front side-wall 107 of the pass box 105 in a closed condition by the locking member 110, and a second angular position, which is usually a vertical position, in which the door 106 is released for opening and the locking member 110 is pivoted in a vertical position. In such pass boxes 105 it is a well-established measure that the locking member 110 protrudes beyond a rim of the opening in the side-wall 107 of the pass box 105, to provide a clear and unambiguous visible control whether the door 106 is properly closed (locking member 110 positioned in the first angular position, in which it is usually received in a catch 111) or not (locking member 110 not positioned in the first angular position). A similar door with a rotary handle and locking member is also provided on the opposite rear side of the pass box 105, which is positioned in the inner volume of the clean room 100.

During use, when the rotary door handle is rotated about its rotation axis for opening or closing the door, it often happens that the locking member accidentally is rotated back to an angular position in-between the locking position and the release position, which may cause damage of the gasket by the accidental collision of the locking member with the gasket and which is a common source of damage and also contamination in such pass boxes.

There is an ongoing need to prevent the generation of contaminants in pass boxes of the afore-mentioned kind as best as possible.

Rotary door handles of similar configuration are also used in various different fields, such as hinged windows for campervans, and damage of rubber gaskets by a wrongly positioned locking member is a common problems experienced also in such other fields of application.

### SUMMARY OF INVENTION

According to the present invention there is provided a rotary handle for opening and closing a door or a window in a side-wall, in particular for use in a pass box for clean rooms, said door or window being configured to be pivoted between a closed condition and an opened condition, said rotary handle comprising: a main body, configured for rotatably supporting the rotary handle about a rotation axis defined by the main body, a locking member, configured for locking the door or window at the side-wall in the closed condition, and a coupling arm coupling a front end of the main body with the locking member, wherein the rotary handle is configured to be mounted on a first side of the door or window with the main body extending through the door or window to a second side opposite to said first side, and the rotary handle is configured to be rotated about the rotation axis between a locking condition, in which the locking member is disposed at a first angular position for locking the door or window in the closed condition, and an opening condition, in which the locking member is disposed at a second angular position to release the door or window for opening. According to the present invention the rotary handle comprises a locking mechanism, configured for locking the rotary handle both in the locking condition and in the opening condition to prevent rotation of the rotary handle about the rotation axis so that the locking member is automatically locked in the second angular position when opening and closing the door or window.

As the rotary handle is automatically locked once the second angular position has been reached (corresponding to the opening condition), the locking member cannot collide with a gasket sealing the rim of an opening of the door or window while the door or window is opened or closed. Thus, the afore-mentioned source of contaminants and damage can be reliably prevented, even if the rotary handle is operated by a user in a negligent manner. Any collision of the locking member with the gasket is reliably prevented, because the door or window can only be opened once the opening position has been reached by the rotary handle, and the rotary handle, and thus the associated locking member, remains locked in this opening position.

The rotary handle may further comprise a release member configured for actuating and selectively releasing the locking mechanism in the locking condition and in the opening condition to enable rotation of the locking member about the rotation axis between the second angular position and the first angular position. Opening the door or window is only enabled after actuating the release member and pivoting the rotary handle to the second angular position and, once the second angular position is reached, the locking mechanism is automatically locked to prevent rotation of the rotary handle about the rotation axis when opening and closing the door or window. Actuating the release member may be associated with an audible noise, such a ‘click’-sound, that can be well perceived by the user and will provide a positive feedback to the user that the opening position has been reached, and the door or window is ready to be opened or closed.

According to a further embodiment, the locking mechanism may be configured for locking the rotary handle both in the locking condition and in the opening condition by positive-fit and the release member may be configured to release the positive-fit by displacement, when actuated, for releasing the locking of the rotary handle. For this purpose, a member and counter-member may be provided closely mated to each other to enable such a positive-fit. When the positive-fit between the member and counter-member, the afore-mentioned audible sound may be generated automatically.

According to a further embodiment, the release member may be configured to lock the rotary handle in a home position, for preventing rotation of the rotary handle about the rotation axis, and to release the rotary handle by displacement from the home position, when actuated, for rotation of the rotary handle about the rotation axis between the locking condition and the opening condition.

According to a further embodiment, the release member may be resiliently biased towards the home position and configured to be displaced from the home position along the rotation axis for releasing the locking of the rotary handle.

According to a further embodiment, the locking mechanism may comprise: an actuating member rotatably supported in a chamber defined by a main body of the rotary handle, and an actuated member rotatably supported in the chamber and coupled with the locking member, wherein the actuated member comprises a radial protrusion protruding in an outward radial direction from a main body of the actuated member, a locking protrusion is provided on an inner surface of the chamber, protruding in an inward radial direction from the inner surface of the chamber, and the actuating member is configured to displace the actuated member along the rotation axis between a first axial position, in which the locking protrusion is not engaged with the radial protrusion of the actuated member and the rotary handle can freely rotate about the rotation axis, and a second position, in which the locking protrusion is engaged with the radial protrusion of the actuated member and the rotary handle is locked selectively in the locking condition or in the opening condition to prevent rotation of the rotary handle about the rotation axis and lock the locking member selectively in the second angular position or in the first angular position.

According to a further embodiment, the locking protrusion may be annular and may comprise two free spaces at angular positions displaced relative to each other by 90 degrees, for defining the rotary position of the actuated member in the locking condition and in the opening condition of the rotary handle.

According to a further embodiment, a free space may be provided on a side of the locking protrusion remote from the actuating member, which is delimited by a radial step delimiting an axial length of the chamber.

According to a further embodiment, an axial protrusion may be formed at a front end of the actuated member facing the actuating member, said axial protrusion being rotatably supported in a sleeve formed at a front end of the chamber.

According to a further embodiment, the coupling arm may comprise a first portion mounted to the front end of the rotary handle and extending in a radial direction perpendicular to the rotation axis, wherein a second portion is bent away from the first portion, and the locking member is plate-shaped and extends in the radial direction perpendicular to the rotation axis.

According to a further embodiment, the rotary handle may further comprise clamping portions for clamping the door or window.

According to a further embodiment, the rotary handle may be configured to be positioned in a horizontal position at the first angular position and in a vertical position at the second angular position.

According to a separate unitary aspect of the present invention there is provided a pass box for the transfer of an article into or out of a clean room, comprising a door or window separating a clean room side from an outside of said pass box, wherein the door or window is pivotably supported at a side-wall of said pass box, in which an opening is formed, and the door or window is configured to be pivoted between a closed condition, in which the opening is closed by said door, and an opened condition, in which the door or window is opened. According to the present invention the pass box comprises a rotary handle as outlined in the present application, said rotary handle being mounted at said door and configured to be rotated about a rotation axis, for opening and closing the door, wherein the rotary handle is rotatably supported at a main body coupling the rotary handle with a locking member and defining a rotation axis, and the rotary handle is configured to be rotated about the rotation axis between a locking condition, in which the locking member is disposed at a first angular position, to lock the door at a side-wall of the pass box in the closed condition, and an opening condition, in which the locking member is disposed at a second angular position, to release the door for opening.

According to a further embodiment, a coupling arm is mounted to the rotary handle for coupling the rotary handle with the locking member, wherein the coupling arm comprises a first portion extending in a radial direction perpendicular to the rotation axis, a second portion bent away from the first portion, and the locking member is plate-shaped and extends in the radial direction perpendicular to the rotation axis; and a receiving member is mounted to a side-wall of the pass box, configured for receiving the locking member and locking the door in the closed condition; wherein a circumferential gasket is provided along the perimeter of an opening of the pass box defined in a front side-wall of the pass box, and the receiving member comprises a slanted sidewall facing the front side-wall of the pass box, for pushing the door against the gasket when the rotary handle rotates the locking member into the receiving member.

According to a further embodiment, a first distance is defined between the rotation axis and an inner rim of the circumferential gasket, and a second distance is defined between the rotation axis and a front free end of the locking member at the first angular position, wherein the second distance is larger than the first distance.

According to a further embodiment, the rotary handle may be configured to be positioned in a horizontal position at the first angular position and in a vertical position at the second angular position.

According to a separate unitary aspect of the present invention there is provided a use of a rotary handle as outlined above in a pass box used for the transfer of an article or items into or out of a clean room. The clean room comprises a vertical side-wall, where the pass box is mounted. The pass box comprises a door or window separating a clean room side from an outside (the environment side) of said pass box and clean room, and the door or window is pivotably supported at a side-wall of said pass box, in which an opening is formed. The door or window is configured to be pivoted between a closed condition, in which the opening is closed by said door, and an opened condition, in which the door or window is opened. According to the present invention the pass box comprises a rotary handle as outlined in the present application, said rotary handle being mounted at said door and configured to be rotated about a rotation axis, for opening and closing the door, wherein the rotary handle is rotatably supported at a main body coupling the rotary handle with a locking member and defining a rotation axis, and the rotary handle is configured to be rotated about the rotation axis between a locking condition, in which the locking member is disposed at a first angular position, to lock the door at a side-wall of the pass box in the closed condition, and an opening condition, in which the locking member is disposed at a second angular position, to release the door for opening.

### TECHNICAL EFFECTS OF INVENTION

The rotary handle can be rotated about rotation axis between a first angular position, which is usually a horizontal position, in which the door or window is locked, e.g. at the side-wall of the pass box in a closed condition, and a second angular position, which is usually a vertical position, in which the door or window is released for opening and in which the locking member is pivoted in a vertical position and not accommodated in the receiving member (catch).

The locking mechanism automatically locks the angular position of the rotary handle both in the locking condition and in the opening condition and prevents rotation of the rotary handle about the rotation axis.

Opening the door is only enabled, after the user has actuated the release member and pivoted the door handle to the second angular position. Once this second angular position is reached, the locking mechanism is automatically locked again, which ensures that the rotary handle and the locking member will remain in the second angular position as long as the door or window is open. When the door or window is to be closed again, the rotary handle and the locking member will remain locked in the opening position and hence the locking member will remain locked in the second angular position. In this second angular position, the locking member cannot damage the gasket provided around the opening at the side-wall. Hence, the gasket cannot be damaged accidentally while the door or window is closed.

When a user has closed the door or window completely, he/she can then actuate the release button to thereby unlock the rotary handle, which can then be pivoted to the closed condition, in which the locking member is accommodated in the receiving member. Once the rotary handle has been rotated by 90 degrees to the closed position, the rotary handle will get locked again automatically. The door or window can only be opened again by pushing the release button again.

The whole procedure for opening and closing the door is very intuitive, can be learnt easily by users as a general routine procedure for opening and closing doors or windows and can prevent reliably an accidental damaging of the gasket, as the locking member cannot collide with the gasket provided around the periphery of the opening of the door or window for sealing.

In the field of pass boxes for clean rooms, the above measures can efficiently reduce the risk of damaging the gasket accidentally when a window or door of a pass box is opened and closed, thus eliminating a common source of contamination in such pass boxes or clean rooms.

### OVERVIEW ON DRAWINGS

Hereinafter, the preferred embodiments according to the present invention will be described in an exemplary manner and with reference to the accompanying drawings, wherein:

FIG. 1 shows a pass box according to the present invention for the transfer of an article into a clean room in a condition when the door is being opened;

FIG. 2 is a cross-sectional view of the front side of the pass box of FIG. 1;

FIG. 3 is a partial cross-sectional view of the door handle according to the present invention along its longitudinal axis;

FIG. 4 is a perspective exploded view of the door handle according to the present invention;

FIGS. 5a and 5b show the door handle according to the present invention in a locked condition;

FIGS. 5c and 5d show the door handle according to the present invention in a released condition; and

FIG. 6 shows a pass box according to the prior art.

Throughout the drawings, the same reference numerals designate identical or technically equivalent elements or groups of elements.

### DETAILED DESCRIPTION OF PREFERRED EMBODIMENTS

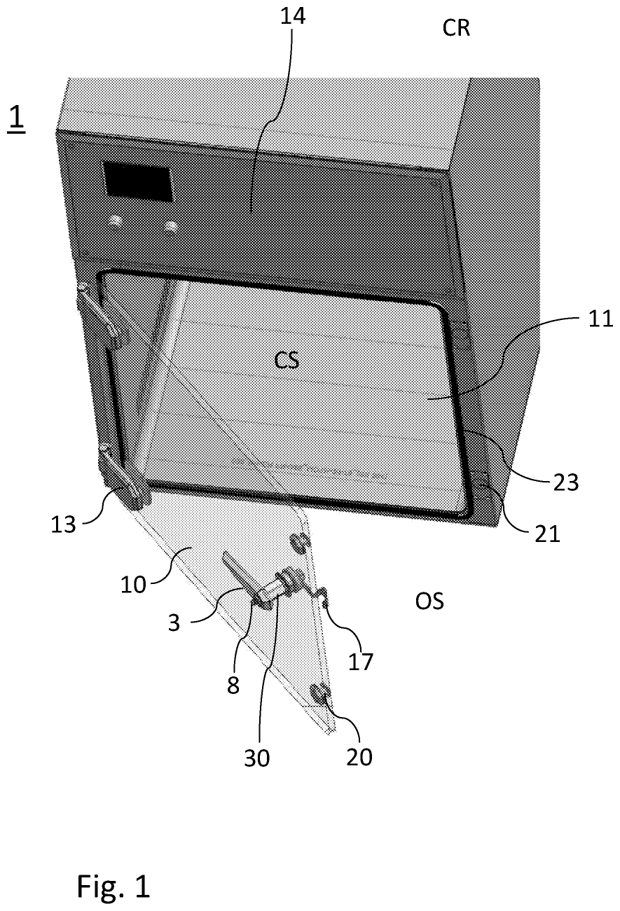

The general configuration of a pass box 1 according to the present invention is shown in FIG. 1. The pass box 1 is usually positioned in a side-wall of a clean room (schematically indicated by reference numeral CR in the drawing). The pass box 1 is used for the transfer of articles, probe samples or materials into and out of a clean room. An opening 11 is provided in a front sidewall 14 of the pass box, and another opening is provided at an opposite rear side-wall of the pass box 1 facing the clean room CR. The opening 11 is closed by a door 10, usually a glass door. A circumferential gasket 23 is provided along the perimeter of the opening 11 in a groove provided in the front side-wall 14. The gasket 23 is clamped between the side-wall 14 and the door 10 in a closed condition of the door 10, to seal the inner volume CS of the pass box 1 against the outside OS on the front side-wall 14. In the same way, a door may also be provided at the rear side (not shown) of the pass box 1 to seal the inner volume CS of the pass box 1 against the clean room CR on the opposite rear side-wall of the pass box 1.

The door 10 is pivotably supported by a door fitting assembly 13 at the left-hand side of sidewall 14 and can be opened by pivoting about a vertical rotation axis. A locking member 17 is provided at the right-hand side of door 10 and the locking member 17 is coupled fixedly with a rotary door handle 3 via a coupling arm 16. The coupling arm 16 may comprise a first portion 16a mounted to a front end of the rotary handle 3 on the clean room side CS thereof and extending in a radial direction perpendicular to the rotation axis 5, and a second portion 16b bent away from the first portion 16a, and the plate-shaped locking member 17 may extend in the radial direction perpendicular to the rotation axis 5. A receiving member 18, such as a catch, is mounted to a side-wall of the pass box 1 on the clean room side CS thereof, and is configured for receiving the locking member 17 in the closed condition, particularly in a positive-fit manner, for locking the door 10 in the closed condition. The receiving member 18 may comprise a slanted side-wall 19 facing the front side-wall 14 of the pass box, so that the door 10 will be pushed further against the gasket 23 when the rotary handle 3 rotates the locking member 17 into the receiving member 18.

The rotary door handle 3 can be rotated about rotation axis 5 between a first angular position, which is usually a horizontal position, in which the door 10 is locked at the side-wall 14 of the pass box 1 in a closed condition, and second angular position, which is usually a vertical position, in which the door 10 is released for opening and in which the locking member 17 is pivoted in a vertical position and not accommodated in the receiving member 18. The rotary door handle 3 comprises a main body 30, usually of cylindric shape, that is pivotably supported at the door or window 10, as outlined below in more detail. The rotary handle 3 may be actuated by pivoting the grip 35 provided at its front end, that may be coupled (or integrally formed) with the main body 30.

A locking mechanism is provided, configured for automatically locking the angular position of the rotary handle 3 both in the locking condition and in the opening condition and prevent rotation of the rotary handle about the rotation axis 5. A release member 8, which may be embodied as a push button 8 at the front end of door handle 3, can release the locking mechanism to enable rotation of the door handle 3 about rotation axis 5, but is biased to a home position, in which the rotary handle 3 is locked in the locking condition or in the opening condition. Accordingly, once the rotary handle 3 has been rotated from the locking condition to the opening condition and reached the opening condition, in which the locking member is not accommodated in the receiving member 18 (and does not lock the door 10 anymore), the locking mechanism is automatically locked again to prevent rotation of the rotary handle 3 about the rotation axis 5 while the door 10 is opened or closed.

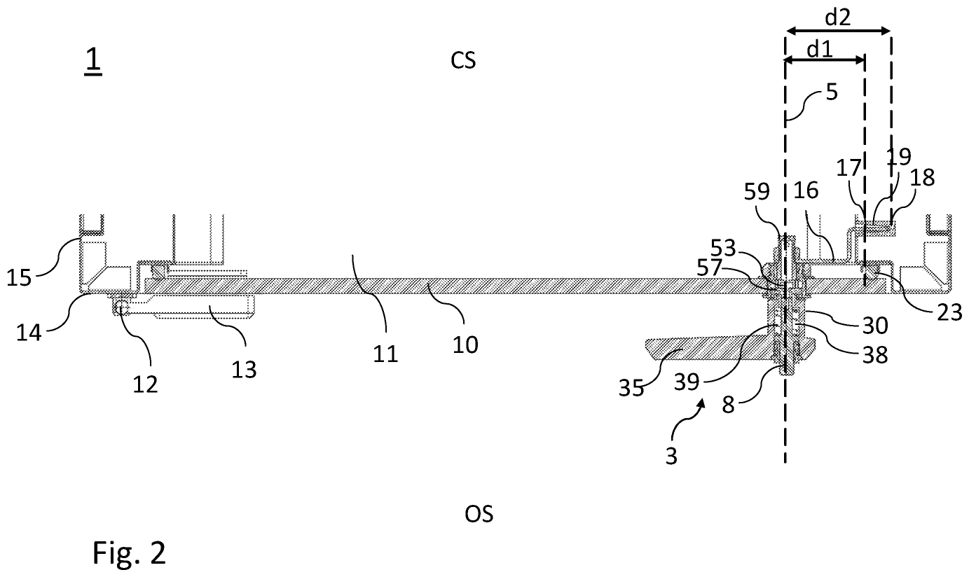

As shown in FIG. 2, in the closed condition of door 10, the locking member 17 and the door handle 3 may be positioned in a horizontal position. For opening the door 10, the button 8 needs to be pushed first, because otherwise the rotary handle 3 cannot be rotated. Pushing the button 8 will then release the locking of the door handle 3, which is then free to rotate about the rotation axis 5. As can be concluded from FIGS. 1 and 2, the door 10 can only be opened when the locking member 17 and the door handle 3 are pivoted fully to the opened position, particularly by 90 degrees to a vertical position, i.e. to its second angular position. In any angular position before reaching this vertical position, the locking member 17 will still abut an edge of opening 11, and the door 10 cannot yet be opened.

According to the present invention, the locking mechanism is automatically locked when the second angular position, is reached, i.e. when the door handle 3 and the locking member 17 have reached the opening position. This locking ensures that the door handle 3 and the locking member 17 will remain in the second angular position when the door is opened. In this second angular position, the locking member 17 cannot collide with the gasket 23 around the perimeter of the opening 11.

When the door 10 is to be closed again, the door handle 3 and the locking member 17 will still be locked in the opening position and hence the locking member 17 will be locked in the second angular position. In this angular position, the locking member 17 cannot damage the gasket 23 provided around perimeter of the opening 11 of the pass box 1. Hence, the gasket 17 cannot be damaged accidentally when the door 10 is closed.

Automatically locking the rotary handle 3 both in the locking condition and in the opening condition can be accomplished, because according to the present invention the release member 8 is biased to a home position, in which the rotary handle 3 is locked in the locking condition or in the opening condition. When the door 10 is to be closed, the locking member 17 automatically remains locked in the second angular position. An accidental rotation of the rotary handle 3 in a non-locked state can be prevented reliably.

When a user has closed the door 10 completely, he/she can then actuate the release button 8 to thereby unlock the door handle 3, which can then be pivoted back to the closed condition, in which the locking member 17 is accommodated in the receiving member 18. Once the door handle 3 has been rotated by 90 degrees to the closed position, the rotary handle 3 will be locked again automatically. The door 10 can only be opened by pushing the release button 8 again.

This whole procedure for opening and closing the door, in which a user first has to actuate a release member, such as button 8, the pivot the rotary handle fully to the opened condition, in which the locking member is then automatically locked again, is intuitively, can be learnt easily by users and can prevent reliably an accidental damaging of gasket 23. Locking the locking mechanism can be accompanied by an audible sound, such as a ‘click’-noise, which will be perceived by a user as a positive feedback that the door is ready to be opened or closed.

As shown in FIG. 2, a first distance d1 is defined between the rotation axis 5 of the main body 30 and an inner rim of the circumferential gasket 23 that seals the opening 11, when the door 10 is closed. Moreover, a second distance d2 is defined between the rotation axis 5 of the main body 30 and a front free end of the locking member 17 at the first angular position, in which it is caught in the corresponding receiving member 18 at the side-wall 14 of the pass box 1. As shown in FIG. 2, the second distance d2 is larger than the first distance d1. In other words, the locking member 17 protrudes beyond a rim of the opening 11 in the side-wall 14 of pass box 1. This provides a clear and unambiguous visible control whether the door 10 is properly closed (locking member 17 positioned in the first angular position, which is usually a horizontal position, in which the locking member 17 is received or caught in the receiving member 18) or not (locking member 17 not positioned in the first angular position). If the rotary handle 3 were not rotated by 90 degrees from the first angular position to the second angular position (usually the vertical position) but positioned in an angular position in-between the locking position and the release position and the door 10 were opened in this in-between position, the locking member 17 would damage the gasket 23, resulting in a severe risk of intrusion of contaminations into the pass box 1.

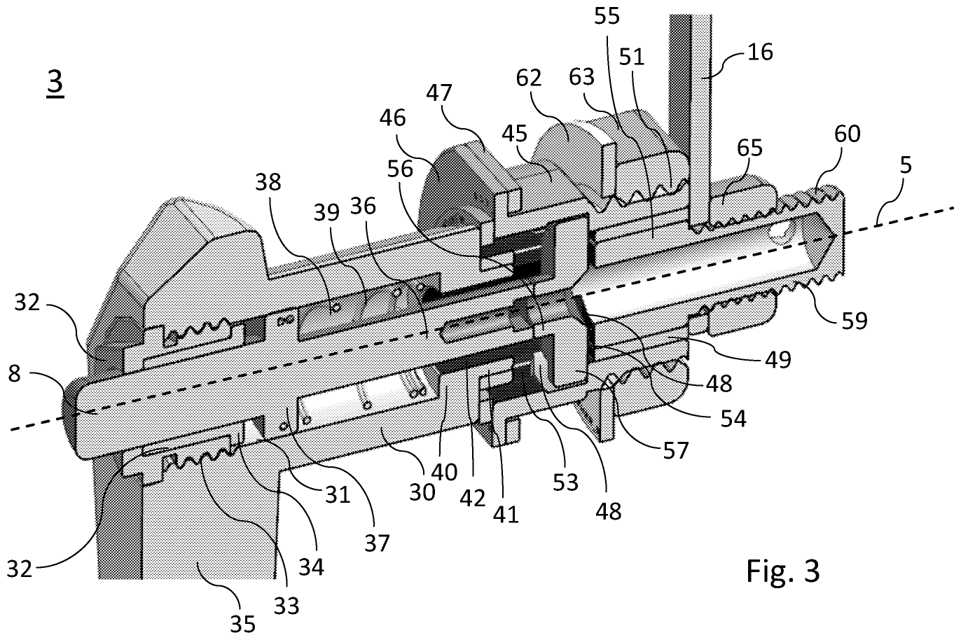

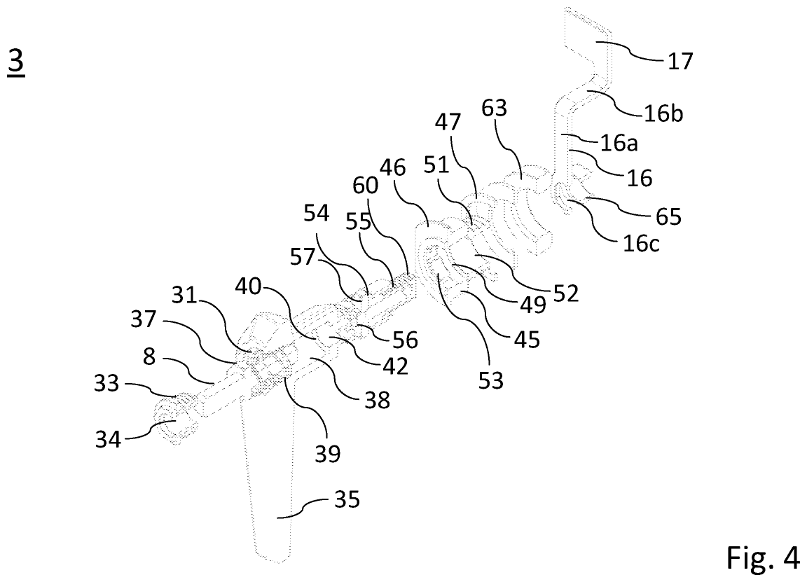

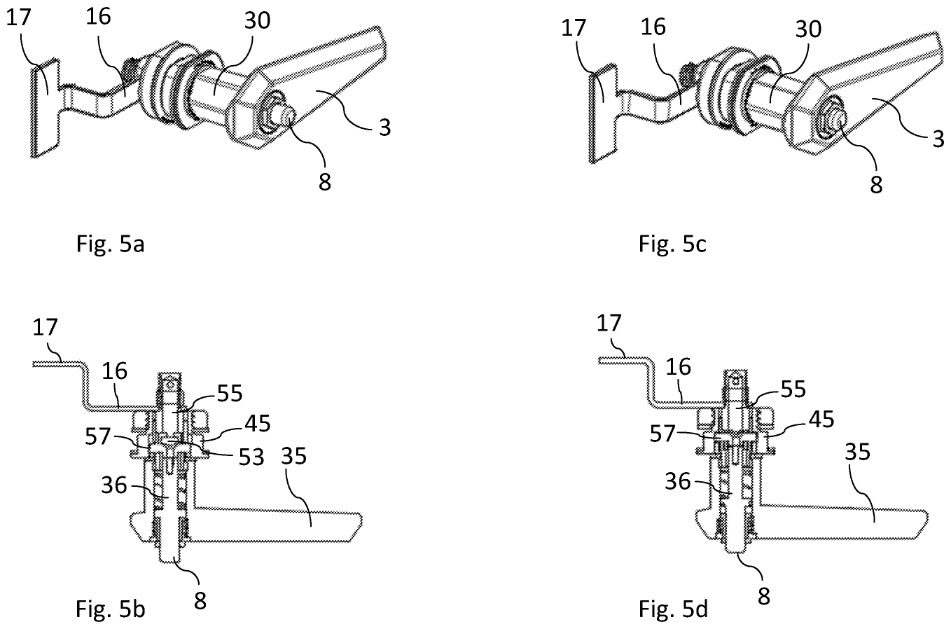

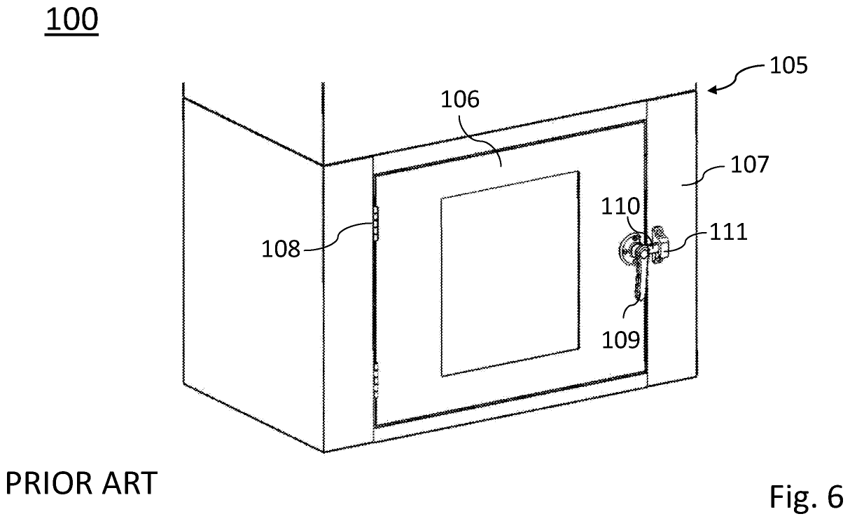

In the following a particular embodiment of a locking and release mechanism will be described in more detail with reference to FIGS. 3 and 4. It will be appreciated by the skilled person, that such a locking and release mechanism may also be implemented in various technically equivalent manners within the scope of the present invention.

Generally, the door handle 3 comprises a first portion of a larger outer diameter and a front end 56 of a reduced diameter, which is rotatably supported in the sleeve-like inner chamber 48 of a counter member 45. The counter member 45 extends through a hole in the door 10 and clamps it and is thus fixedly mounted to the door 10. The door handle 3 includes a pushed rod 55 that can be displaced in axial direction. In a home position, the pushed rod 55 locks the angular position of door handle 3 in a positive-fit manner, whereas in a second position, when the pushed rod 55 is pushed forward by release button 8, the positive-fit of the pushed rod 55 is released and the door handle 3 is free to be rotated about rotation axis 5, relative to counter member 45.

On its front end the handle 3 includes a cylindrical recess 31 as part of a cylindrical inner chamber 38, which slidably houses both an actuating member, namely the release button 8 with its pushing rod 36, and the actuated member, namely the pushed rod 55. A threading 33 is formed on an inner side-wall of recess 31 and a nut 33 secures a sliding sleeve 34 inside the recess 31, which delimits the position of the release button 8 in axial direction by abutment of a radial protrusion 37 against the front end of the sliding sleeve 34. The front end 41 of chamber 38 narrows by radial step 40 to an inner bore 42 of a reduced diameter, which corresponds to the diameter of the front end of pushing rod 36 and to the diameter of the opposite front end 56 of pushed rod 55, which are both guided in this inner bore 42 for axial displacement.

The release button 8 is resiliently biased towards a home position, in which the locking mechanism is locked either in the closed position or in the opening position. For this purpose, a spring 39 is accommodated in the inner chamber 38, of which the first end abuts against the radial protrusion 37 and of which the second end, opposite to the first end, abuts against the radial step 40.

The constricted front end 41 of door handle 3 with its inner bore 42 is accommodated in the sleeve-like inner bore 52 at the front end of the cylindrical counter member 45, which includes an inner chamber 48 of a larger diameter. Two opposite radial protrusions 57 are provided at the front end of pushed rod 55. A longitudinal slot 54 is provided in the side-wall of constricted front end 41 of door handle 3, and the two opposite radial protrusions 57 extend through this longitudinal slot 54 into the inner chamber 48 of larger diameter of counter member 45. The diameter of this inner chamber 48 basically corresponds to the outer width of the radial protrusions 57 of pushed rod 55. The width of the longitudinal slot 54 corresponds to the widths of the radial protrusions 57 at the front end of pushed rod 55, so that the pushed rod 55 can only be displaced along the axial direction, which is identical with the rotation axis 5, but not be rotated about the rotation axis 5 relative to the door handle 3. In other words, the angular position of pushed rod 55 is fixedly coupled with the angular position of door handle 3.

As can be seen best in FIG. 4, a series of locking protrusions 53 is provided on an inner surface of the inner chamber 48, each protruding in an inward radial direction from the inner surface of the chamber 48. In a preferred embodiment, the locking protrusion 53 is annular and comprises at least two free spaces, in some embodiments four free spaces, disposed at angular positions displaced relative to each other by 90 degrees. These free spaces serve for defining the rotary position of the actuated member 55 in the locking condition and in the opening condition of the rotary handle 3 by positive-fit with the radial protrusions 57 of the pushed rod 55. The widths of these free spaces correspond to the width of the radial protrusions 57 at the front end 56 of pushed rod 55.

As can be seen best in FIG. 4, an annular free space is provided on a side of the locking protrusions 53 remote from the pushing rod 36, and this annular free space in the wider inner chamber 48 is delimited in axial direction by a radial step 49, thus delimiting an axial length of the chamber 38.

When the release button 8 is pushed downward and into the recess 31 of handle 3, the pushing rod 36 will be pushed forward and get in contact with the front end 56 of pushed rod 55. Thus, the pushed rod 35 will be pushed forward and the radial protrusions 57 will enter the afore-mentioned free space in the wider inner chamber 48. The foremost axial position of pushed rod 55 will be defined by abutment of the radial protrusions 57 against the radial step 49 of inner chamber 48 of counter member 45, which also defines the foremost axial position of release button 8. In this position, the handle 3 together with pushed rod 55 can be rotated freely about rotation axis 5 relative to counter member 45. Hence in the foremost axial position of the pushed rod 55 the locking mechanism of the door handle 3 is released and un-locked.

As the spring 39 resiliently biases the release button 8 towards the retracted home position, the pushed rod 55 will not be pushed forward in this home position, and the radial protrusions 57 of pushed rod 55 will be accommodated in the corresponding free spaces or recesses of locking protrusion 53. In this position, the door handle 3 cannot be rotated about the rotation axis 5, as it is locked due to the positive-fit of the radial protrusions 57 of pushed rod 55 with the free spaces of locking protrusion 53.

When the door 10 is in its closed position and the release button 8 in its home position, the locking member 17 is in the horizontal locking position. When the release button 8 is pushed downward against the biasing force of spring 39 and pushes the pushing rod 55 forward, the positive-fit of the radial protrusions 57 of pushed rod 55 with the free spaces of locking protrusion 53 will be released, and the door handle 3 can be rotated about the rotation axis 5. The door 10 can, however, only be opened once the locking member 17 has been pivoted towards the vertical opening position. In this position, the radial protrusions 57 of pushed rod 55 will be finally aligned with the adjacent free spaces of locking protrusion 53, and the biasing force will then push the release button 8 back to its home position, which will cause the radial protrusions 57 of pushed rod 55 to jump into the adjacent free spaces of locking protrusion 53 and result in an automatic locking of the angular position of both the pushed rod 55 and door handle 3 again. Hence, in the opened position, the locking mechanism will automatically lock the door handle 3 and prevent its rotation.

In this angular position of door handle 3, i.e. the vertical position of door handle 3, the door 10 can be closed again. Because the door handle 3 remains locked, the locking member 17 will remain in its vertical position and cannot damage the gasket 23 of pass box 1. Once the door 10 has been closed completely, the user will then push release button 8 downward against the biasing force of spring 39, which will result in a displacement of pushing rod 55 in forward direction along the rotation axis 5. Finally, the positive-fit of the radial protrusions 57 of pushed rod 55 with the free spaces of locking protrusion 53 will be released, and the door handle 3 can be rotated about the rotation axis 5. Finally, the locking member 17 is pivoted to its horizontal locking position again, which corresponds to the horizontal position of door handle 3 again. In this position, the radial protrusions 57 of pushed rod 55 will be finally aligned again with the adjacent free spaces of locking protrusion 53, and the biasing force of spring 29 will then push the release button 8 back to its home position, which will cause the radial protrusions 57 of pushed rod 55 to jump into the adjacent free spaces of locking protrusion 53 and result in an automatic locking of the angular position of both the pushed rod 55 and door handle 3 again. Hence, in the closed position, the locking mechanism will automatically lock the door handle 3 and prevent its rotation.

The door 10 can only be opened again by first pushing the release button 8 downward and into the recess 31 of handle 3, to thereby release again the locking mechanism.

As shown in FIGS. 3 and 4, the door handle 3 comprises clamping portions 46, 63 provided on the clean room side CS and on the outside OS of door 10, respectively, for clamping the door 10. An outer threading 51 is provided at the front end 41 of door handle 3, and the clamping portion 63 is a nut that can be tightened on the threading 51, for clamping the door 10. Washers 47, 62 are provided between the door 10 and the clamping portions 46, 63 to uniform the contact pressure.

A second outer threading 60 is provided on the front end 59 of door handle 3 and a nut 65 is tightened on this outer threading 60 to clamp the hook-shaped portion 16c of the coupling arm 16 used for coupling the door handle 3 with the locking member 17. The hook-shaped clamping portion 16c is at the free front end of a first portion 16a of coupling arm 16 extending in a radial direction perpendicular to the rotation axis 5, which is followed by a second portion 16b bent away from the first portion 16a, in a direction in parallel with the rotation axis 5, which is followed by the locking member 17 that is plate-shaped and extends in the radial direction perpendicular to the rotation axis 5, as shown in FIG. 4.

As will become apparent to a skilled person when studying the above disclosure, a rotary handle as outlined above can be used also in various other technical fields, such as hinged windows for campervans or houses, to prevent damage of rubber gaskets by a wrongly positioned locking member. In such applications, but also in use for pass boxes for clean rooms, the locking member and the rotary handle may also be positioned on the same side of the door or window to be opened and closed.

What is claimed is:

1. A rotary handle for opening and closing a door or a window in a side-wall, said door or window being configured to be pivoted between a closed condition and an opened condition, said rotary handle comprising:
a main body, configured for rotatably supporting the rotary handle about a rotation axis defined by the main body,
a locking member, configured for locking the door or window at the side-wall in the closed condition, and
a coupling arm coupling a front end of the main body with the locking member; wherein
the rotary handle is configured to be mounted on a first side of the door or window with the main body extending through the door or window to a second side opposite to said first side, and
the rotary handle is configured to be rotated about the rotation axis between a locking condition, in which the locking member is disposed at a first angular position for locking the door or window in the closed condition, and an opening condition, in which the locking member is disposed at a second angular position to release the door or window for opening; wherein
the rotary handle comprises a locking mechanism and a release member,
said locking mechanism being configured for locking the rotary handle both in the locking condition and in the opening condition, and
said release member being configured for actuating and selectively releasing the locking mechanism in the locking condition and in the opening condition to enable rotation of the locking member about the rotation axis between the second angular position and the first angular position; wherein
opening the door or window is only enabled after actuating the release member and pivoting the rotary handle to the second angular position, and
once the second angular position is reached, the locking mechanism is automatically locked to prevent rotation of the rotary handle about the rotation axis when opening and closing the door or window.

2. The rotary handle as claimed in claim 1, wherein
the locking mechanism is configured for locking the rotary handle both in the locking condition and in the opening condition by positive-fit, and
the release member is configured to release the positive-fit by displacement, when actuated, for releasing the locking of the rotary handle.

3. The rotary handle as claimed in claim 2, wherein
the release member is configured
to lock the rotary handle in a home position, for preventing rotation of the rotary handle about the rotation axis in the home position, and
to release the rotary handle from the home position by displacement, when actuated, for enabling rotation of the rotary handle about the rotation axis between the locking condition and the opening condition.

4. The rotary handle as claimed in claim 2, wherein
the release member is resiliently biased towards the home position, and
the release member can be displaced from the home position along the rotation axis for releasing the locking of the rotary handle.

5. The rotary handle as claimed in claim 1, wherein the locking mechanism comprises:
an actuating member rotatably supported in a chamber defined by a main body of the rotary handle, and
an actuated member rotatably supported in the chamber and coupled with the locking member; wherein
the actuated member comprises:
a radial protrusion protruding in an outward radial direction from a main body of the actuated member, and
a locking protrusion is provided on an inner surface of the chamber, protruding in an inward radial direction from the inner surface of the chamber; wherein
the actuating member is configured to displace the actuated member along the rotation axis between a first axial position, in which the locking protrusion is not engaged with the radial protrusion of the actuated member and the rotary handle can freely rotate about the rotation axis, and a second position, in which the locking protrusion is engaged with the radial protrusion of the actuated member and the rotary handle is locked selectively in the locking condition or in the opening condition to prevent rotation of the rotary handle about the rotation axis and lock the locking member selectively in the second angular position or in the first angular position.

6. The rotary handle as claimed in claim 5, wherein
the locking protrusion is annular and comprises two free spaces at angular positions displaced relative to each other by 90 degrees, for defining the rotary position of the actuated member in the locking condition and in the opening condition of the rotary handle.

7. The rotary handle as claimed in claim 5, wherein
a free space is provided on a side of the locking protrusion remote from the actuating member, which is delimited by a radial step delimiting an axial length of the chamber.

8. The rotary handle as claimed in claim 5, wherein
an axial protrusion is formed at a front end of the actuated member facing the actuating member, said axial protrusion being rotatably supported in a sleeve formed at a front end of the chamber, and
a free space is provided on a side of the locking protrusion remote from the actuating member, which is delimited by a radial step delimiting an axial length of the chamber.

9. The rotary handle as claimed in claim 6, wherein
an axial protrusion is formed at a front end of the actuated member facing the actuating member, said axial protrusion being rotatably supported in a sleeve formed at a front end of the chamber.

10. The rotary handle as claimed in claim 1, wherein the coupling arm comprises
a first portion mounted to the front end of the rotary handle and extending in a radial direction perpendicular to the rotation axis and away from the main body, and
a second portion bent away from the first portion and extending in parallel with the rotation axis; wherein
the locking member is plate-shaped and extends in the radial direction perpendicular to the rotation axis and perpendicular to the first portion.

11. The rotary handle as claimed in claim 1, said rotary handle further comprising clamping portions for clamping the door or window.

12. The rotary handle as claimed in claim 1, wherein the rotary handle is in a horizontal position at the first angular position and in a vertical position at the second angular position.

13. A pass box for the transfer of an article into or out of a clean room, comprising
a side-wall having an opening, and
a door or window separating a clean room side from an outside of said pass box; wherein
the door or window is pivotably supported at the side-wall, for selectively opening and closing said opening, and
the door or window is pivotably supported at said side-wall and configured to be pivoted between a closed condition, in which the opening is closed by said door, and an opened condition, in which the door or window is opened;
said door or window comprising a rotary handle mounted at said door and configured to be rotated about a rotation axis, for opening and closing the door, said rotary handle comprising:
a main body rotatably mounted to said door or window and rotatably supporting the rotary handle about a rotation axis defined by the main body,
a locking member for locking the door or window at the side-wall in the closed condition, and
a coupling arm coupling a front end of the main body with the locking member; wherein
the rotary handle is mounted on a side of the door or window facing the outside of the pass box and with the main body extending through the door or window to the clean room side opposite to said outside, and
the rotary handle can be rotated about the rotation axis between a locking condition, in which the locking member is disposed at a first angular position for locking the door or window in the closed condition, and an opening condition, in which the locking member is disposed at a second angular position to release the door or window for opening; wherein
the rotary handle comprises a locking mechanism and a release member,
said locking mechanism being configured for locking the rotary handle both in the locking condition and in the opening condition, and
said release member being configured for actuating and selectively releasing the locking mechanism in the locking condition and in the opening condition to enable rotation of the locking member about the rotation axis between the second angular position and the first angular position; wherein
opening the door or window is only enabled after actuating the release member and pivoting the rotary handle to the second angular position, and
once the second angular position is reached, the locking mechanism is automatically locked to prevent rotation of the rotary handle about the rotation axis when opening and closing the door or window.

14. The pass box as claimed in claim 13, said pass box further comprising:
a receiving member mounted to the side-wall of the pass box, configured for receiving the locking member and locking the door in the closed condition, and
a circumferential gasket provided along a perimeter of the opening of the pass box defined in the side-wall of the pass box; wherein
the receiving member comprises a slanted side-wall facing the front side-wall of the pass box, for pushing the door against the gasket when the rotary handle rotates the locking member into the receiving member.

15. The pass box as claimed in claim 14, wherein
a first distance is defined between the rotation axis and an inner rim of the circumferential gasket, and
a second distance is defined between the rotation axis and a front free end of the locking member at the first angular position, wherein
the second distance is larger than the first distance.

16. The pass box as claimed in claim 14, wherein
a coupling arm is mounted to the rotary handle, for coupling the rotary handle with the locking member, wherein
the coupling arm comprises:
a first portion mounted to a front end of the rotary handle and extending in a radial direction perpendicular to the rotation axis and away from the main body, and
a second portion bent away from the first portion and extending in parallel with the rotation axis; wherein
the locking member is plate-shaped and extends in the radial direction perpendicular to the rotation axis and perpendicular to the first portion.

17. The pass box as claimed in claim 14, wherein
the locking mechanism is configured for locking the rotary handle both in the locking condition and in the opening condition by positive-fit, and
the release member is configured to release the positive-fit by displacement, when actuated, for releasing the locking of the rotary handle; wherein
the release member is configured
to lock the rotary handle in a home position, for preventing rotation of the rotary handle about the rotation axis in the home position, and
to release the rotary handle from the home position by displacement, when actuated, for enabling rotation of the rotary handle about the rotation axis between the locking condition and the opening condition; wherein
the release member is resiliently biased towards the home position, and
the release member can be displaced from the home position along the rotation axis for releasing the locking of the rotary handle.

18. The pass box as claimed in claim 14, wherein the locking mechanism comprises:
an actuating member rotatably supported in a chamber defined by a main body of the rotary handle, and
an actuated member rotatably supported in the chamber and coupled with the locking member; wherein
the actuated member comprises:
a radial protrusion protruding in an outward radial direction from a main body of the actuated member, and
a locking protrusion is provided on an inner surface of the chamber, protruding in an inward radial direction from the inner surface of the chamber; wherein
the actuating member is configured to displace the actuated member along the rotation axis between a first axial position, in which the locking protrusion is not engaged with the radial protrusion of the actuated member and the rotary handle can freely rotate about the rotation axis, and a second position, in which the locking protrusion is engaged with the radial protrusion of the actuated member and the rotary handle is locked selectively in the locking condition or in the opening condition to prevent rotation of the rotary handle about the rotation axis and lock the locking member selectively in the second angular position or in the first angular position.

19. The pass box as claimed in claim 18, wherein
the locking protrusion is annular and comprises two free spaces at angular positions displaced relative to each other by 90 degrees, for defining the rotary position of the actuated member in the locking condition and in the opening condition of the rotary handle.

20. The pass box as claimed in claim 14, wherein the rotary handle is in a horizontal position at the first angular position and in a vertical position at the second angular position.
